(19) United States
(12) Patent Application Publication
(10) Pub. No.: US 2026/0104581 A1
(43) Pub. Date: Apr. 16, 2026

(54) PIVOT MOUNT SYSTEM FOR SECONDARY OPTICAL DEVICE

(71) Applicant: WILCOX INDUSTRIES CORP., Newington, NH (US)

(72) Inventors: Gary M. Lemire, Lee, NH (US); Timothy E. West, Park City, MT (US)

(21) Appl. No.: 19/353,766

(22) Filed: Oct. 9, 2025

Related U.S. Application Data
(60) Provisional application No. 63/705,685, filed on Oct. 10, 2024.

(51) Int. Cl. G02B 23/16; F41G 11/00

(52) U.S. Cl. CPC G02B 23/16; F41G 11/003; F41G 11/007

(57) ABSTRACT

A pivot mount is provided for a secondary optical device which pivots between a stowed position where in the secondary optical device is positioned out of a line of sight of a user and a deployed position, which is aligned with an optical axis of a primary optical device, which allows through sighting of the secondary optic for enhancing operator effectiveness in a variety of conditions. In one aspect, a first pivot mount apparatus is attachable to a primary optical device for selectively positioning a secondary optical device in optical alignment with the primary optical device. In another aspect, a second pivot mount apparatus is attachable to the primary optical device for selectively positioning a tertiary optical device in optical alignment with the primary optical device.

### CROSS REFERENCE TO RELATED APPLICATION

This application claims the priority benefit of U.S. Provisional Patent Application No. 63/705,685 filed October 10, 2024. The aforementioned application is incorporated herein by reference in its entirety.

### BACKGROUND

The present disclosure relates to weapon optics and, in particular, to a pivot mount system for a secondary optical device which pivots between a stowed position where in the secondary optical device is positioned out of a line of sight of a user and a deployed position, which is aligned with an optical axis of a primary optical device, which allows through sighting of the secondary optic for enhancing operator effectiveness in a variety of conditions.

### SUMMARY

In one aspect, a first pivot mount apparatus is attachable to a primary optical device for selectively positioning a secondary optical device in optical alignment with the primary optical device. In another aspect, a second pivot mount apparatus is attachable to the primary optical device for selectively positioning a tertiary optical device in optical alignment with the primary optical device.

In embodiments, an optical mounting system comprises a first support structure configured to couple to a first optical device and a second optical device. The first optical device and second optical device have a first optical axis and a second optical axis, respectively. The first support structure defines a first joint defining a first pivot axis., The first pivot axis extends in a direction transverse to the first optical axis. The second optical device is pivotable about the first pivot axis. When the first support structure is coupled to the first optical device and the second optical device, the second optical device is pivotable between a first viewing position wherein the second optical device is operably positioned in front of the first optical device and wherein the first optical axis and the second optical axis are substantially aligned; and a second viewing position wherein the second optical device is substantially axially aligned with the first optical device and wherein the first optical axis and the second optical axis are offset from each other and substantially parallel to each other.

In a more limited aspect, when the first support structure is coupled to the first optical device and the second optical device, the second optical device is pivotable between the first viewing position wherein the second optical device is operably positioned in front of the first optical device and wherein the first optical axis and the second optical axis are substantially aligned; and the second viewing position wherein the second optical device is positioned above the first optical device and wherein the first optical axis and the second optical axis are vertically offset from each other and extend substantially parallel to each other.

In another more limited aspect, the first support structure comprises a first pivot arm configured to be coupled to the first optical device and a second pivot arm configured to be coupled to the second optical device. The second pivot arm comprises a second pivot joint configured to allow rotation of the second optical device about a second pivot axis. The first optical axis, first pivot axis, and second pivot axis are mutually orthogonal when the first support structure is coupled to the first optical device and the second optical device and when the second optical device is in the second viewing position.

In another more limited aspect, the second pivot joint is configured to rotate the second optical device between a first rotational position wherein a viewing end of the second optical device is disposed in a user-facing direction when the first optical device is attached to the first pivot arm and the second optical device is attached to the second pivot arm and the second optical device is in the first viewing position; and a second rotational position wherein the viewing end of the second optical device is disposed in a user-facing direction when the first optical device is attached to the first pivot arm and the second optical device is attached to the second pivot arm and the second optical device is in the second viewing position.

In another more limited aspect, the optical mounting system further comprises an auxiliary rail segment configured to be disposed on the first optical device, the auxiliary rail segment being configured to detachably couple to the first pivot arm.

In another more limited aspect, the second pivot joint includes a rotatable accessory rail segment which is rotatable about the second pivot axis.

In another more limited aspect, the second pivot joint comprises a boss coupled to the rotatable accessory rail segment and rotatably received within a bore in the second pivot arm. The bore extends along the second pivot axis. First and second pivot lock notches are formed on the boss and spaced 180 degrees apart about the second pivot axis. A pivot lock member is disposed on the second pivot art and has a locking tooth configured to selectively engage the first and second pivot lock notches.

In another more limited aspect, the optical mounting system further comprises a second support structure configured to couple to the first optical device and a third optical device, the third optical device defining a third optical axis. The second support structure defining a third pivot joint defines a third pivot axis which extends parallel to the first optical axis about which the third optical device is pivotable when the second support structure is coupled to the first optical device and the third optical device. When the second support structure is coupled to the first optical device and the third optical device, the third optical device is pivotable between a third viewing position, wherein the third optical device is operably positioned behind the first optical device and wherein the first optical axis and the third optical axis are substantially aligned; and a fourth viewing position, wherein the third optical device is displaced with respect to the first optical axis, wherein the third optical axis is offset from and extends substantially parallel to the first optical axis.

In another more limited aspect, the second support structure comprises a third pivot arm configured to be coupled to the first optical device and a fourth pivot arm configured to be coupled to the third optical device.

In another more limited aspect, the fourth pivot arm comprises a ring clamp configured to secure to a generally tubular housing of the third optical device.

In another more limited aspect, the optical mounting system further comprises a rail interface assembly configured to detachably the first optical device to a weapon rail interface.

In another more limited aspect, the rail interface assembly comprises a clamp portion configured to detachably couple to a Picatinny rail.

In another aspect, a method of positioning a first optical device relative to a support structure is provided. The support structure defines a first pivot axis, which extends transverse to an optical axis of the first optical device, and a rotation axis. The first pivot axis, optical axis, and rotation axis are mutually orthogonal when the first optical device is in a viewing position. The method includes the steps of pivoting the first optical device about the first pivot axis between a first position and a second position and rotating the first optical device about the rotation axis to orient a viewing end of the first optical device toward a user.

In a more limited aspect, the method further comprises providing a second optical device and pivoting the second optical device about a second pivot axis between a third position and a fourth position, wherein the second pivot axis extends parallel to the optical axis when the first optical device is in the viewing position.

In another more limited aspect, pivoting the first optical device comprises pivoting the first optical device approximately 180° between a first orientation and a second orientation and rotating the first optical device comprises rotating the first optical device approximately 180° between the second orientation and a third orientation.

In another more limited aspect, a viewing end of the first optical device is configured to be disposed toward a user when the first optical device is in the first orientation and third orientation.

In another more limited aspect, the first optical device is selected from the group consisting of a reflex sight, night vision device, video display device, thermal camera, optical sight, and optical magnifier.

In another more limited aspect, rotating comprises engaging detents on a rotation joint to releasably retain the optical device at a selected one of the second and third orientations.

Various advantages and benefits of the present development will become apparent to those skilled in the art upon reading and understanding the following detailed description of the preferred embodiments.

### BRIEF DESCRIPTION OF THE DRAWINGS

The invention may take form in various components and arrangements of components, and in various steps and arrangements of steps. The drawings are only for purposes of illustrating preferred embodiments and are not to be construed as limiting the invention.

FIG. 1 is an isometric view of a weapon employing an exemplary embodiment of pivot mount system in conjunction with a primary optical device.

FIG. 2 is an enlarged isometric view of the primary optical device with a secondary optical device pivot mount and a rear optical device pivot mount, wherein secondary and rear optical devices, respectively, are positioned in optical alignment with the primary optical device.

FIG. 3 is an enlarged isometric view showing the secondary optical device in the deployed position.

FIG. 4 is an enlarged isometric view showing the secondary optical device in an intermediate stowed position.

FIG. 5 is an enlarged isometric view showing the secondary optical device in a final stowed position where the primary and secondary optical devices are usable independently of each other.

FIG. 6 is an enlarged isometric view of the secondary optical device pivot mount.

FIG. 7 is an exploded isometric view of the secondary optical device pivot mount.

### DETAILED DESCRIPTION OF THE PREFERRED EMBODIMENTS

Reference will now be made in detail to presently preferred embodiments of the invention, one or more examples of which are illustrated in the accompanying drawings. Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

Detailed embodiments of the present development are disclosed herein. However, it is to be understood that the disclosed embodiments are merely exemplary of the invention, which may be embodied in various forms. Therefore, specific structural and functional details disclosed herein are not to be interpreted as limiting but merely as a basis for the claims and as a representative basis for teaching one skilled in the art to variously employ the present inventive concept in virtually any appropriately detailed structure. Further, the terms and phrases used herein are not intended to be limiting but rather to provide an understandable description of the present development.

The terms “a” or “an,” as used herein, are defined as one or more than one. The term “another,” as used herein, is defined as at least a second or more. The terms “including” and/or “having” as used herein, are defined as comprising (i.e., open transition). The terms “attached,” “coupled,” “operatively coupled,” etc., as used herein, is defined as indirectly or directly connected.

As used in this application, the terms “front,” “rear,” “upper,” “lower,” “upwardly,” “downwardly,” “left,” “right,” and other orientation descriptors are intended to facilitate the description of the exemplary embodiment(s) of the present invention in relation to the provided figures, and are not intended to limit the structure thereof to any particular position or orientation.

As used herein, the term “optical device” refers to any device that assists in the observation, tracking, targeting, or acquisition of a target by a user, including but not limited to devices that utilize visible light, infrared radiation, thermal radiation, or other electromagnetic spectra. The term “optical device” encompasses, without limitation, optical and electro-optical devices, including scopes, magnifying accessory, reflex (e.g., red dot) sights, holographic sights, cameras, and other devices that rely on lenses to enhance the user’s vision of a target; night vision devices (NVDs), including passive and active night vision scopes, goggles, and monoculars that amplify ambient light or use infrared illumination to enable vision in low-light environments; thermal sights, including thermal imaging scopes and devices that detect heat signatures and provide a visual representation of a target based on infrared radiation; enhanced night vision devices (ENVDs), including systems that integrate traditional night vision technology with thermal imaging or other imaging modalities to provide improved target detection and identification in low-light or obscured conditions; and other hybrid or multi-spectrum imaging technologies.

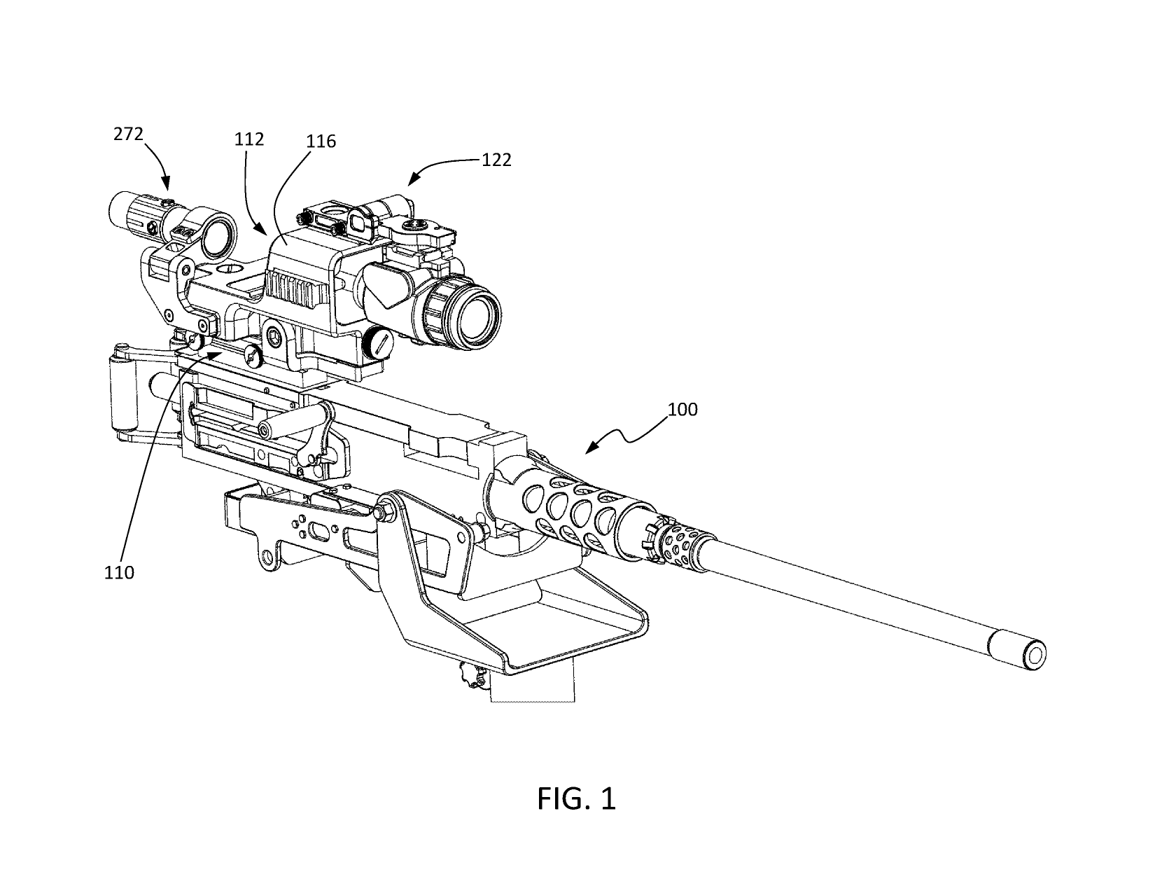

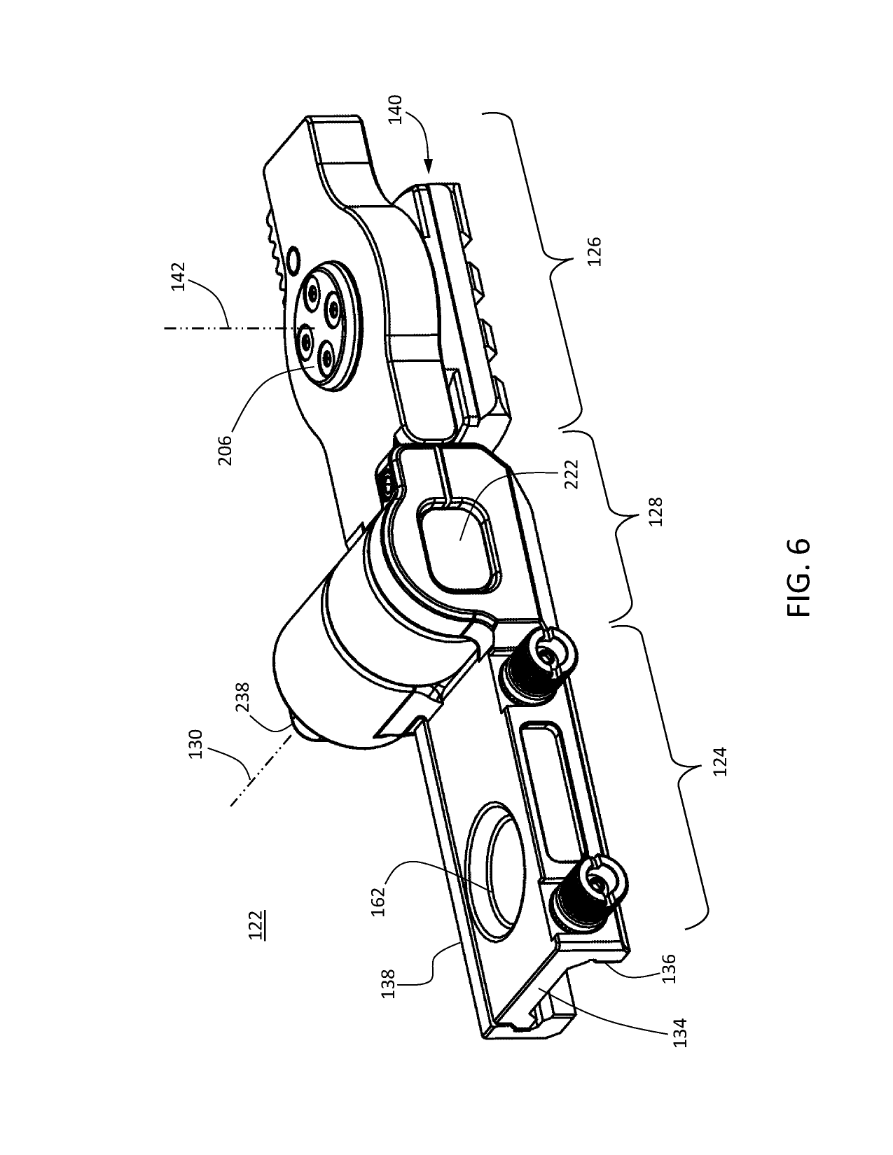

With reference to FIGS. 1-7, there is shown a weapon 100 having an accessory rail assembly 110 disposed on an upper surface, e.g., of a receiver portion, thereof. In the illustrated exemplary embodiment, the weapon 100 is an M2 heavy machine gun. In alternative embodiments, the weapon 100 may be a rifle, shotgun, carbine, mortar, grenade launcher, submachine gun, light machine gun, missile launcher, rocket launcher, and so forth. In embodiments, the accessory rail assembly 110 includes a Picatinny rail interface (e.g., MIL-STD-1913 or STANAG 4694) as would be understood by persons skilled in the art, although other accessory rail interfaces are contemplated.

A primary optical device 112 is detachably coupled to the accessory rail assembly 110, via a rail interface assembly 114, such as a rail clamp assembly. In the illustrated embodiment, the rail interface assembly 114 is attached to a housing 116 of the primary optical device 112, which encloses the internal components of the primary optical device 112, via threaded fasteners 118. In preferred embodiments, the primary optical device 112 is a reflex or red dot sight, although other types of optical devices may be used as the primary optical device 112, as will be readily appreciated by those skilled in the art.

The housing 116 includes one or more auxiliary accessory rail segments 120 configured to provide a mounting interface to support the attachment of piggyback devices. In the illustrated embodiment, the auxiliary accessory rail segments 120 are Picatinny rail segments. A first pivot mount assembly 122 includes a first pivoting segment 124 which is pivotally attached to a second pivoting segment 126 via a hinge section 128. The hinge section defines a pivot axis 130 which extends transversely with respect to an optical axis 132 of the primary optical device 112.

The first pivoting segment 124 includes a mount base 134 having a fixed rail clamp member 136 and a movable rail clamp member 138. The first pivoting segment 124 detachably couples the first pivot mount assembly 122 to the auxiliary accessory rail section 120 disposed on the upper surface 125 of the housing 116. The second pivoting segment 126 includes a rotatable accessory rail segment 140, which is rotatable about a vertical pivot axis 142. The first pivot mount assembly 122 has a longitudinal axis which is parallel to the optical axis 132 of the primary optical device 112.

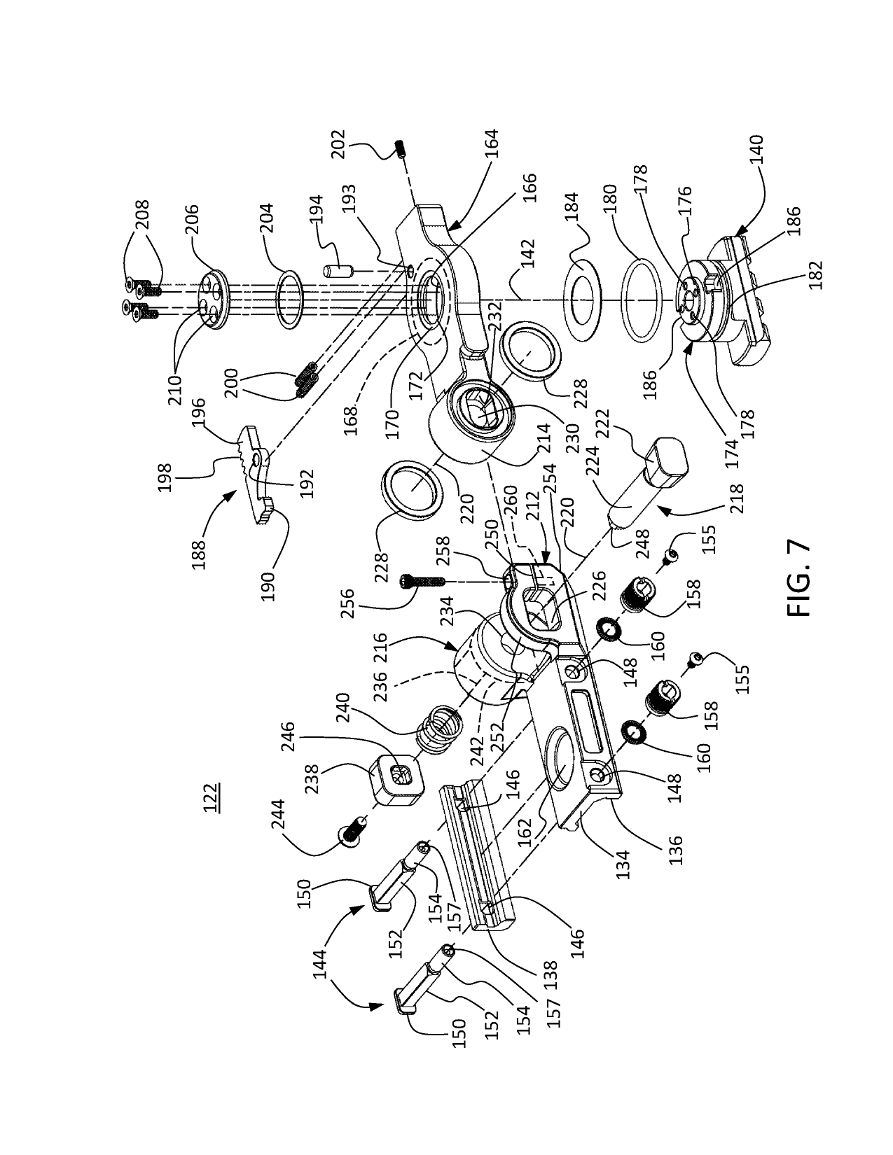

As best seen in FIG. 7, and with continued reference to FIGS. 1-6, the movable rail clamp member 138 is secured to the mount base 134 via first and second drawbars 144. The drawbars 144 pass through respective clearance openings 146 in the movable rail clamp member 138 and corresponding aligned clearance openings 148 in the mount base 134. Each drawbar 144 has an enlarged diameter head 150 located at one end, which is designed to engage with a surface of the movable rail clamp member 138, thereby preventing the drawbar from passing entirely through the clearance opening 146. Each drawbar 144 further includes an elongated shaft portion 152 extending from the head 150 and terminates in a threaded end 154.

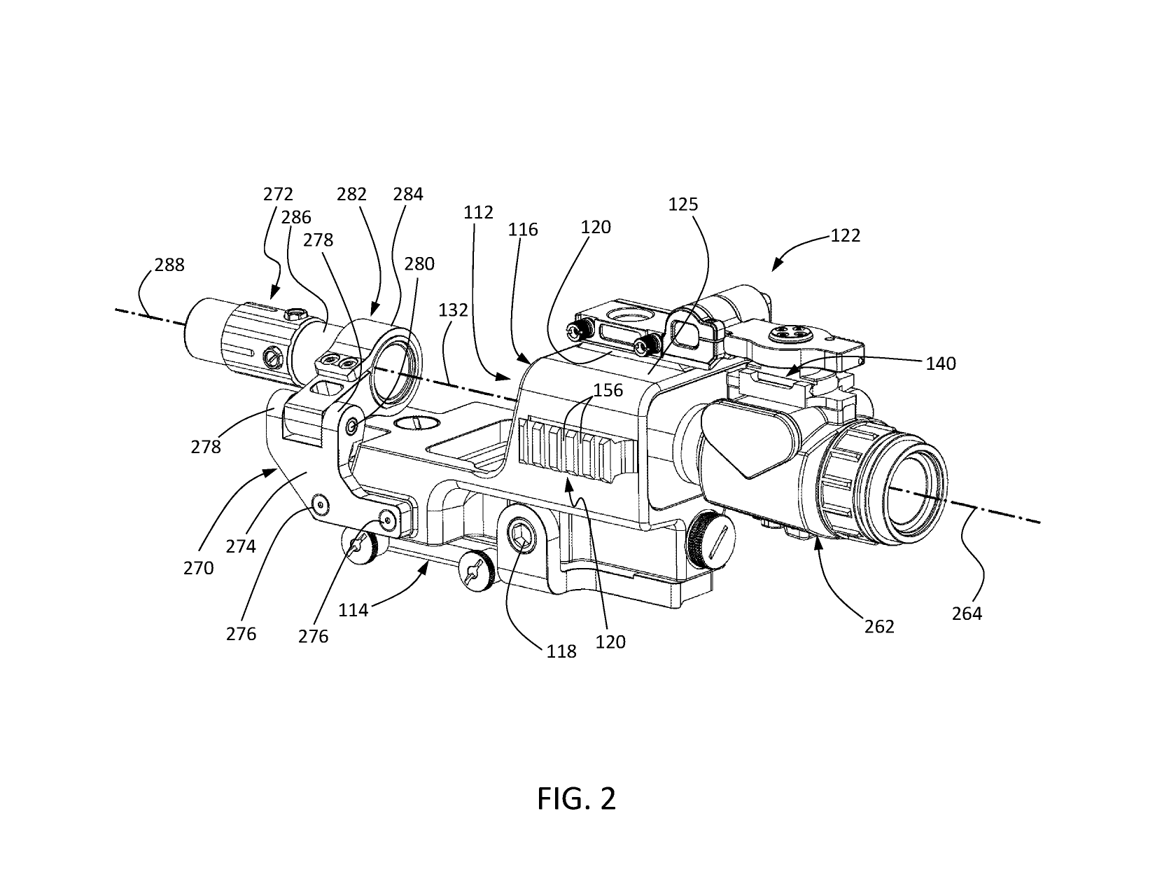

In embodiments, the elongated shaft portions 152 of the drawbars 144 have a generally rectangular cross sectional shape and are spaced and configured to be received at least partially within spaced apart recoil grooves 156 (see FIG. 2) in the auxiliary accessory rail section 120. The threaded ends 154 pass though the respective clearance openings 148 and threadably engage corresponding thumb nuts 158, wherein tightening the thumb nuts 158 causes the rail clamp members 136, 138 to be drawn together to exert a clamping force on the auxiliary accessory rail section 120 positioned between them.

In the illustrated embodiment, a washer 160 is disposed between each of the thumb nuts 158 and the rail clamp member 136. In embodiments, the washers 160 are lock washers configured to resist loosening, e.g., under vibrational and recoil forces, such as serrated washers, spring washers, split ring washers, and so forth. A vertically-extending bore or recess 162 is disposed on the mount base 134. Threaded fasteners 155 threadably engage tapped openings 157 in the threaded ends 154 of the drawbars 144 to capture or secure the thumb nuts 158 relative to the drawbars 144 to allow selective loosening and tightening of the fixed rail clamp member 136 in relation to the movable rail clamp member 138 for the purpose of removal and attachment of the first pivot mount assembly 122 to the auxiliary accessory rail segment 120.

The second pivoting segment 126 includes a locking deployment arm 164 having a vertically extending bore 166 along the vertical axis 142, a first counterbore 168 disposed on the lower (in the orientation depicted in FIG. 7) side of the arm 164 and a second counterbore 170 disposed on the upper (in the orientation depicted in FIG. 7) side of the arm 164 which cooperate to define an inward flange 172. The rotatable accessory rail section 140 includes an upstanding (in the orientation depicted in FIG. 7) boss 174. The boss 174 extends into the first counterbore 168 and includes a raised elevated center portion 176 sized to extend into the bore 166. A plurality of female threaded openings 178 are formed in the center portion 176.

A tensioning ring 180 is received within an annular groove 182 on the boss 174 and bears against the sidewall of the first counterbore 168. In the illustrated embodiment, a first glide washer 184 is positioned coaxially around the raised elevated center portion 176 of the boss 174. The glide washer 184 may be formed of a low friction material, such as nylon, polytetrafluoroethylene (PTFE), or other polymer material to facilitate rotation of the rail section 140.

First and second pivot lock notches 186 are formed on the boss 174 and are spaced 180 degrees apart from each other. The notches 186 are configured to engage with a pivot lock member 188. The pivot lock member 188 includes a locking tooth 190 dimensioned to releasably engage with an aligned one of the pivot lock notches 186. An opening 192 on the pivot lock member 188 and an opening 193 on the arm 164 receive opposing ends of a pivot pin 194. An actuator arm 196 on the pivot lock member 188 is disposed opposite the locking tooth 190. Optionally, a series of notches 198 or other textured surface may be provided to improve grip and prevent slippage.

One or more spring members 200 are disposed intermediate the arm 164 and the actuator arm 196 and are configured to bias the locking tooth 190 into engagement with the respective one of the notches 186 to secure the rotatable rail segment 140 in its current position. When it is desired to rotate the rotatable rail segment 140, the arm portion 196 is manually pressed, which compresses the one or more spring members 200 and retracts the locking tooth 190 from the notch 186. The rotatable rail segment 140 may then be rotated 180 degrees. When the rotatable rail segment 140 has been rotated to the desired orientation and the latch arm 196 is released, the spring members 200 urge the locking tooth 190 into engagement with the aligned one of the notches 186. In the illustrated embodiment, a pivot pin locking screw 202 is received within a pre-threaded opening (not shown) and bears against the pivot pin 194 to retain the pivot pin 194 in position.

In the illustrated embodiment, a second glide washer 204, which may be formed of a material as described above by way of reference to the first glide washer 184, is received within the second counterbore 170. A retaining plate 206 is disposed over the second glide washer 204. A plurality of threaded fasteners 208 pass through respective clearance openings 210 in the retaining plate 206 and threadably engage the respective threaded openings 178 in the raised center portion 176 on the boss 174.

The hinge section 128 defines a hinge assembly for allowing pivoting movement between the first and second pivoting segments 124 and 126. The first pivoting segment 124 includes a first hinge knuckle 212 spaced apart from a second hinge knuckle 216. The second pivoting segment 126 includes a third hinge knuckle 214 disposed intermediate the first and second hinge knuckles 212 and 216, respectively.

A pivot pin 218 defines a pivot axis 220 and includes a locking head portion 222 and a shaft portion 224. The pivot pin 218 passes through an opening 226 in the first hinge knuckle 212. The pivot pin head portion 222 has a noncircular (generally rectangular in the illustrated embodiment) cross-sectional shape and the opening 226 is correspondingly shaped. The head 222 is configured to be received within the opening 226. Although depicted as having a generally non-square rectangular shape, the head 222 of the pivot pin 218 and the opening 226 may alternatively have any other geometrical shape having 180-degree rotational symmetry. In preferred embodiments, the cross-sectional shape of the correspondingly-shaped head 222 and opening 226 has an order of rotational symmetry of 2, i.e., half-turn symmetry.

In embodiments, the pivot pin 218 passes through a first tensioning washer 228 which is disposed intermediate the first hinge knuckle 212 and the second hinge knuckle 216. The first tensioning washer 228 maintains friction between the first and second hinge knuckles 212, 216, respectively, to ensure controlled pivoting movement between the first and second pivoting segments 124, 126.

The third hinge knuckle 214 includes an axial bore 230 and a counterbore 232 which is complementary in shape to the head 222 and the opening 226. The pivot pin 218 passes through the counterbore 232 and bore 230 and through a second tensioning washer 228, which is disposed intermediate the second hinge knuckle 216 and the third hinge knuckle 214. The second tensioning washer 228 maintains friction between the second and third hinge knuckles 216, 214, respectively, to ensure controlled pivoting movement between the first and second pivoting segments 124, 126. The counterbore 232 is disposed on the side of the second hinge knuckle 216 that faces the first hinge knuckle 212 and is aligned with the aperture 226. The aperture 226 and the counterbore 232 cooperate to define a generally contiguous receptacle for receiving the pivot pin head 222.

The pivot pin 218 further passes through an axial bore 234 and counterbore 236 in the second hinge knuckle 216. The counterbore 236 opens toward the side of the second hinge knuckle 216 distal to the third hinge knuckle 214. A deploy lock release button 238 is disposed within the counterbore 236. The deploy lock release button 238 and counterbore 236 are correspondingly shaped and the deploy lock release button 238 is slidable within the counterbore 236 along the pivot axis 220. Although the deploy lock release button 238 and counterbore 236 are depicted as having complementary rectangular shapes, it will be recognized that other shapes are also contemplated.

A spring member 240 is received within the counterbore 236. The spring member 240 is depicted as a coil spring in the illustrated embodiment and is coaxially received on the shaft portion 224 of the hinge pivot pin 218. The spring member 240 includes a proximal end which bears against a shoulder 242 of the counterbore 236 and a distal end which bears against the deploy lock release button 238. The spring member 240 biases the deploy lock release button 238 toward the open distal end of the counterbore 236. A threaded fastener 244 passes through a clearance opening 246 in the deploy lock release button 238 and threadably engages a coaxial threaded opening 248 in the distal end of the shaft portion 222 to secure the deploy lock release button 238 to the pivot pin 218.

In embodiments, the first hinge knuckle 212 defines a clamp ring having a gap 250 separating a first arm 252 and a second arm 254. A threaded fastener 256 passes through a clearance opening 258 in the first arm 252 and threadably engages a complementary threaded opening 260 in the second arm 254. In this manner, the threaded fastener 256 can selectively be advanced or retracted to fine tune the size of the opening 226 to control the ease of sliding movement of the head portion 222 with respect to the opening 226 responsive to pressing and releasing the deploy lock release button 238.

In operation, when the first pivot mount assembly 122 is in the extended or non-folded position, as depicted in FIGS. 1-3, 6, and 7, the bias of the spring member 240 urges the deploy lock release button 238 in the distal or outward direction, thereby drawing the head portion 222 in the distal direction so that it simultaneously engages both the counterbore 232 of the third hinge knuckle 214 and the opening 226 of the first hinge knuckle 212. In this manner rotation of the first pivoting segment 124 with respect to the second pivoting segment 126 is prevented.

In the embodiments appearing in FIGS. 1-3, a secondary optical device 262 is detachably coupled to the rotatable rail section 140 with the first pivot mount assembly 122 being in the extended position. In the depicted embodiment, the secondary optical device 262 is a thermal sight for illustrative purposes. It will be recognized that all manner of other optical devices may be employed. When the first pivot mount assembly 122 is in the extended position, an optical axis 264 of the secondary optical device 262 is substantially aligned with the optical axis 132 of the primary optical device 112 that allows viewing of the secondary optical device 262 through the primary optical device 112.

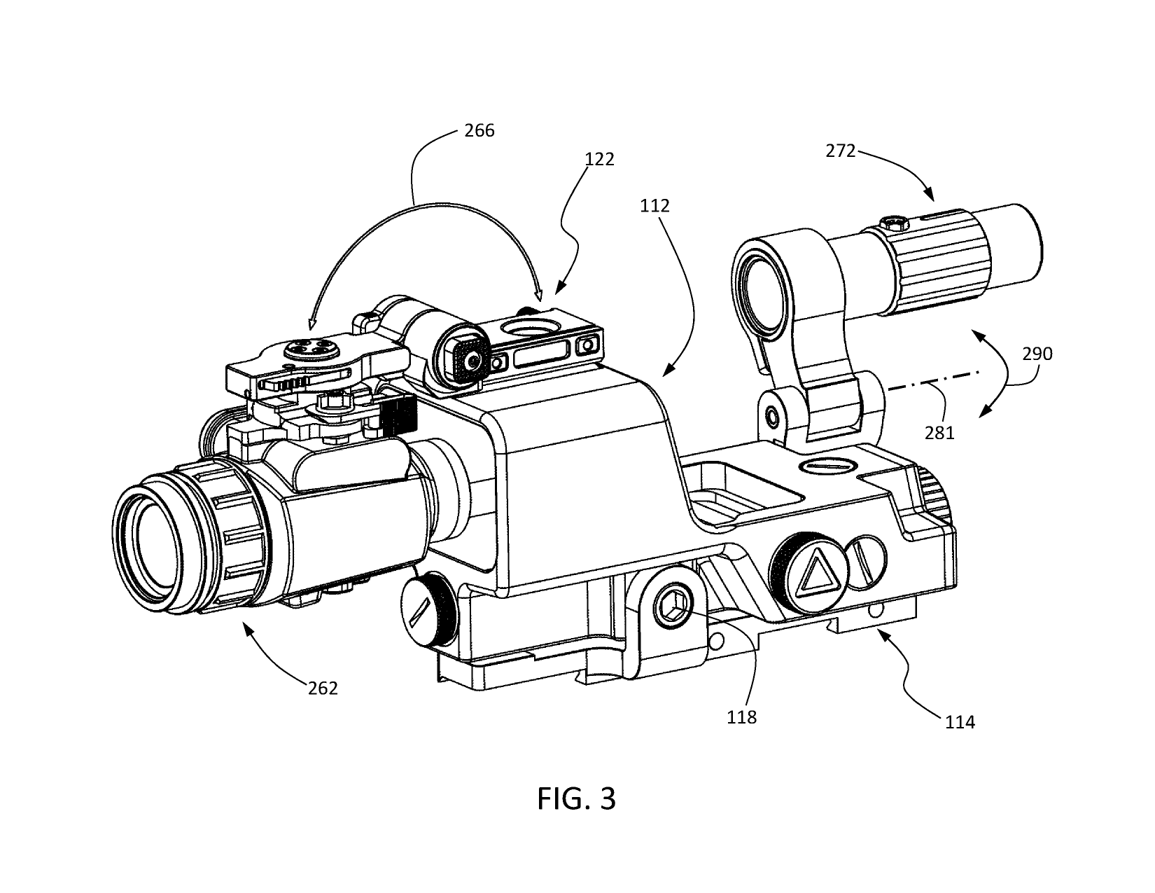

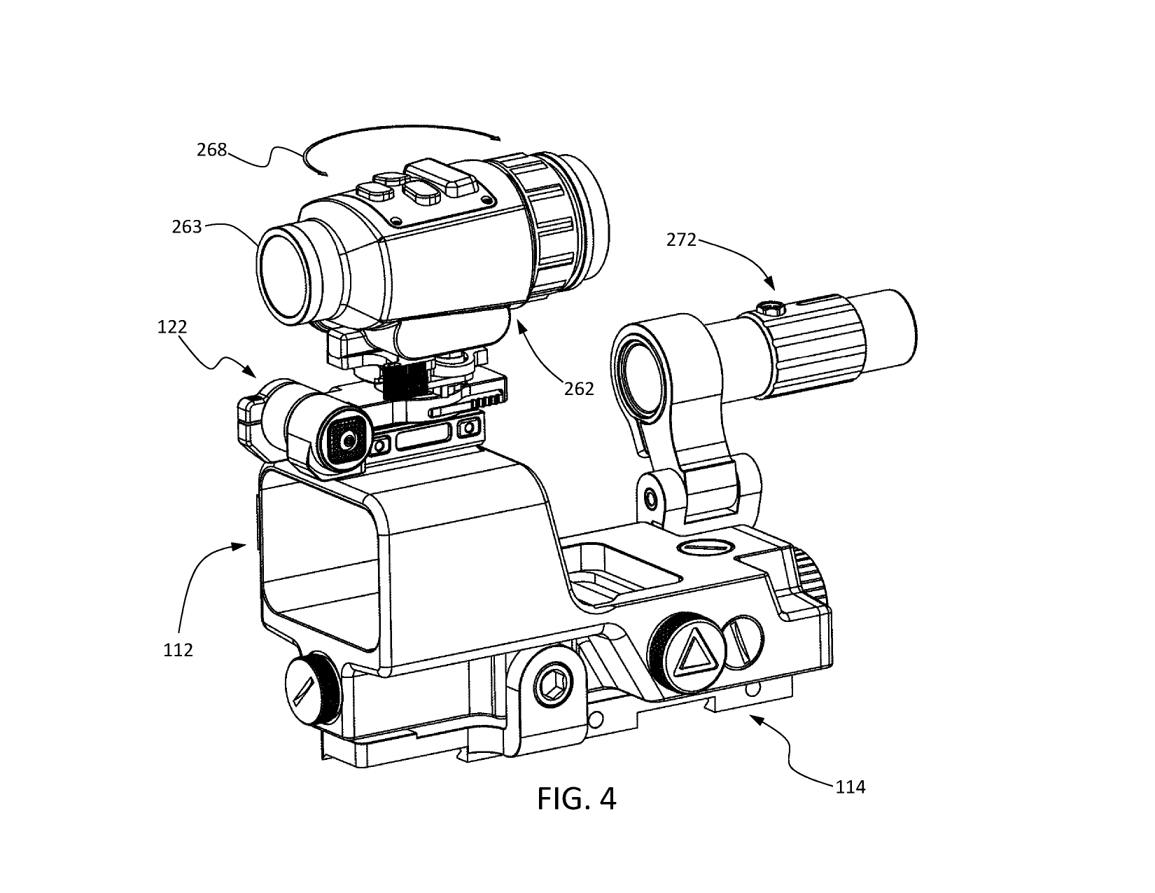

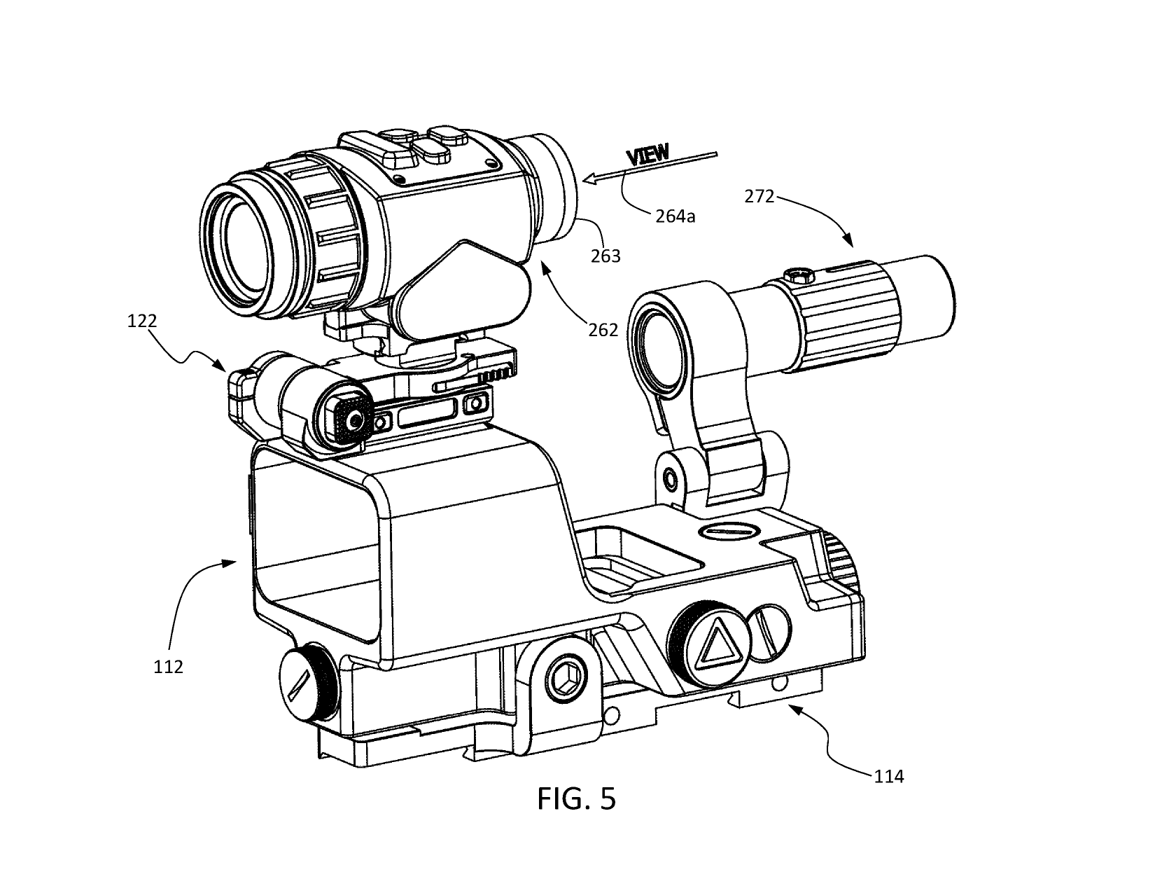

For scenarios where only the primary optical device 112 is needed, the user manually depresses the deploy lock release button 238, compressing the spring member 240 and moving the head portion 222 out of engagement with the counterbore 232 in the third hinge knuckle 214. When the head portion 222 is disengaged from the counterbore 232, the user can manually pivot the second pivoting segment 126 relative to the first pivoting segment 124 as indicated by the arrow 266 in FIG. 3. After pivoting the second pivoting segment 126 180 degrees, the first pivot mount assembly 122 is in the folded position as shown in FIGS. 4 and 5, wherein the secondary optical device 262 is positioned above the primary optical device 112. When the arm 164 is pivoted 180 degrees, the recess or opening 162 in the mount body 134 provides clearance to receive the retaining plate 206, thereby allowing the arm 164 to sit flush against the mount body 134.

For scenarios where it is desired to view the primary and secondary optical devices 112, 262 independently, the user manually depresses the actuator arm 196 of the pivot lock member 188, compressing the spring members 200 and withdrawing the locking tooth 190 from the corresponding lock notch 186 in the pivoting rail boss 174. When the locking tooth 190 is disengaged from the corresponding lock notch 186, the user can manually rotate the secondary optical device 262 180 degrees about the pivot axis 142, as depicted by the arrow 268 appearing in FIG. 4 until the secondary optical device 262 is positioned with the eyepiece 263 facing toward the user, as shown in FIG. 5. This allows the primary optical device 112 and secondary optical device 262 to be mounted in a stacked arrangement, thereby enabling the user to switch between the devices as needed for different shooting scenarios. In the configuration shown in FIG. 5, the user is able to view the primary optical device 112 along the optical axis 132 and the secondary optical device 262 along an optical axis 264a which is elevated above the primary optical device 112.

In certain embodiments, a rear bracket assembly 270 is secured to the housing 116 of the primary optical device 112 for attaching a tertiary optical device 272, which is a rear optical device in the illustrated preferred embodiment. Although in the illustrated exemplary embodiment the secondary optical device 262 is depicted as being positioned in front of the primary optical device 112 and the tertiary optical device 272 is depicted as being positioned behind the primary optical device 112, it should be understood that other configurations are also contemplated. For example, the secondary and tertiary optical devices 262, 272 may be reversed such that the tertiary optical device 272 is disposed in front of the primary optical device 112 and the secondary optical device 262 is disposed behind the primary optical device 112. In other variations, both the secondary and tertiary optical devices 262, 272 may be disposed on the same side of the primary device 112, whether both in front or both behind, in either order. Still further, the relative positions of the primary, secondary, and tertiary optical devices 112, 262, 272 may be rearranged in any order suitable for a particular application, and the present disclosure is not intended to be limited to the specific arrangement shown in the figures.

In embodiments, the rear optical device as a magnifier, such as a 3X magnifier, 4X magnifier, or the like. Other rear optical devices 272 are also contemplated. The rear bracket assembly 270 includes a mounting arm 274 which is secured to the housing 116 via threaded fasteners 276 disposed near a proximal end of the mounting arm 274 and a pair of opposing hinge knuckles 278 which receive a pivot pin 280.

A pivot arm assembly 282 includes a hinge knuckle 284 disposed at a proximal end of the pivot arm assembly 282. The hinge knuckle 284 is pivotal about the pivot pin 280, which defines a pivot axis 281. A distal end of the pivot arm assembly 282 includes a fastener element 284 adapted to secure the rear optical device 272. In the illustrated embodiment, the fastener element 284 is a ring clamp or collar configured to secure a generally tubular body 286 of the rear optical device 272. It will be recognized that the fastener element 284 can be adapted to accommodate other types of rear optical devices. FIGS. 1 and 2 depict the rear optical device 272 pivoted into a deployed position wherein an optical axis 288 of the rear optical device 272 is substantially aligned with the optical axis 132 of the primary optical device 112. When it is not desired to use the rear optical device 272, the rear optical device 272 can be pivoted about the pivot pin 280 to a stowed position so that it is out of the line of sight of the primary optical device 112, as shown in FIGS. 3-5, and as depicted by the arrow 290 appearing in FIG. 3.

In this manner, the sighting system in accordance with the present disclosure provides various viewing configurations to enhance targeting capabilities based on specific needs, lighting conditions, and situational requirements. For example, in one configuration, the primary optical device 112 may be utilized independently (see FIGS. 4 and 5). In another configuration, the primary optical device 112 may be used in conjunction with the secondary optical device 262 (see FIG. 3). In yet another configuration, the primary optical device 112 may be used with both the secondary optical device 262 and the rear optical device 272 (see FIGS. 1 and 2). In still another configuration, the primary optical device 112 may be used solely with the rear optical device 272. In another configuration, the secondary optical device 262 may be utilized independently (see FIG. 5).

In preferred embodiments, the primary optical device 112 is a reflex sight, the secondary optical device 262 is a thermal sight, and the rear optical device 272 is a magnifier. In this preferred embodiment, in one configuration, the reflex sight may be utilized independently (see FIGS. 4 and 5). In another configuration, the reflex sight may be used in conjunction with the thermal sight (see FIG. 3). In yet another configuration, the reflex sight may be used with both the thermal sight and the magnifier (see FIGS. 1 and 2). In still another configuration, the reflex sight may be used solely with the magnifier. In another configuration, the thermal sight may be utilized independently (see FIG. 5).

The invention has been described with reference to the preferred embodiment. Modifications and alterations will occur to others upon a reading and understanding of the preceding detailed description. It is intended that the invention be construed as including all such modifications and alterations insofar as they come within the scope of the appended claims or the equivalents thereof.

What is claimed is:

1. An optical mounting system comprising:
a first support structure configured to couple to a first optical device and a second optical device, the first optical device and second optical device having a first optical axis and a second optical axis, respectively;
the first support structure defining a first joint, the first joint defining a first pivot axis, the first pivot axis extending in a direction transverse to the first optical axis, the second optical device pivotable about the first pivot axis when the first support structure is coupled to the first optical device and the second optical device; and
wherein, when the first support structure is coupled to the first optical device and the second optical device, the second optical device is pivotable between:
a first viewing position wherein the second optical device is operably positioned in front of the first optical device and wherein the first optical axis and the second optical axis are substantially aligned; and
a second viewing position wherein the second optical device is substantially axially aligned with the first optical device and wherein the first optical axis and the second optical axis are offset from each other and substantially parallel to each other.

2. The optical mounting system of claim 1, wherein, when the first support structure is coupled to the first optical device and the second optical device, the second optical device is pivotable between:
the first viewing position wherein the second optical device is operably positioned in front of the first optical device and wherein the first optical axis and the second optical axis are substantially aligned; and
the second viewing position wherein the second optical device is positioned above the first optical device and wherein the first optical axis and the second optical axis are vertically offset from each other and extend substantially parallel to each other.

3. The optical mounting system of claim 1, wherein the first support structure comprises a first pivot arm configured to be coupled to the first optical device and a second pivot arm configured to be coupled to the second optical device, wherein the second pivot arm comprises a second pivot joint configured to allow rotation of the second optical device about a second pivot axis, wherein the first optical axis, first pivot axis, and second pivot axis are mutually orthogonal when the first support structure is coupled to the first optical device and the second optical device and when the second optical device is in the second viewing position.

4. The optical mounting system of claim 3, wherein the second pivot joint is configured to rotate the second optical device between:
a first rotational position wherein a viewing end of the second optical device is disposed in a user-facing direction when the first optical device is attached to the first pivot arm and the second optical device is attached to the second pivot arm and the second optical device is in the first viewing position; and
a second rotational position wherein the viewing end of the second optical device is disposed in a user-facing direction when the first optical device is attached to the first pivot arm and the second optical device is attached to the second pivot arm and the second optical device is in the second viewing position.

5. The optical mounting system of claim 3, further comprising:
an auxiliary rail segment configured to be disposed on the first optical device, the auxiliary rail segment being configured to detachably couple to the first pivot arm.

6. The optical mounting system of claim 3, wherein the second pivot joint includes a rotatable accessory rail segment which is rotatable about the second pivot axis.

7. The optical mounting system of claim 6, wherein the second pivot joint comprises:
a boss coupled to the rotatable accessory rail segment and rotatably received within a bore in the second pivot arm, the bore extending along the second pivot axis;
first and second pivot lock notches formed on the boss and spaced 180 degrees apart about the second pivot axis; and
a pivot lock member disposed on the second pivot art and having a locking tooth, the locking tooth configured to selectively engage the first and second pivot lock notches.

8. The optical mounting system of claim 1, further comprising:
a second support structure configured to couple to the first optical device and a third optical device, the third optical device defining a third optical axis;
the second support structure defining a third pivot joint defining a third pivot axis, the third pivot axis extending parallel to the first optical axis about which the third optical device is pivotable when the second support structure is coupled to the first optical device and the third optical device; and
wherein, when the second support structure is coupled to the first optical device and the third optical device, the third optical device is pivotable between:
a third viewing position, wherein the third optical device is operably positioned behind the first optical device and wherein the first optical axis and the third optical axis are substantially aligned; and
a fourth viewing position, wherein the third optical device is displaced with respect to the first optical axis, wherein the third optical axis is offset from and extends substantially parallel to the first optical axis.

9. The optical mounting system of claim 8, wherein the second support structure comprises a third pivot arm configured to be coupled to the first optical device and a fourth pivot arm configured to be coupled to the third optical device.

10. The optical mounting system of claim 9, wherein the fourth pivot arm comprises a ring clamp configured to secure to a generally tubular housing of the third optical device.

11. The optical mounting system of claim 1, further comprising a rail interface assembly configured to detachably the first optical device to a weapon rail interface.

12. The optical mounting system of claim 11, wherein the rail interface assembly comprises a clamp portion configured to detachably couple to a Picatinny rail.

13. A method of positioning a first optical device relative to a support structure, the support structure defining a first pivot axis transverse to an optical axis of the first optical device and a rotation axis, the first pivot axis, optical axis, and rotation axis being mutually orthogonal when the first optical device is in a viewing position, the method comprising:
pivoting the first optical device about the first pivot axis between a first position and a second position; and
rotating the first optical device about the rotation axis, when the first optical device is attached to the support structure, to orient a viewing end of the first optical device toward a user.

14. The method of claim 13, further comprising:
providing a second optical device; and
pivoting the second optical device about a second pivot axis between a third position and a fourth position, the second pivot axis extending parallel to the optical axis when the first optical device is in the viewing position.

15. The method of claim 13, wherein pivoting the first optical device comprises pivoting the first optical device approximately 180° between a first orientation and a second orientation and wherein rotating the first optical device comprises rotating the first optical device approximately 180° between the second orientation and a third orientation.

16. The method of claim 15, wherein a viewing end of the first optical device is configured to be disposed toward a user when the first optical device is in the first orientation and the third orientation.

17. The method of claim 13, wherein the first optical device is selected from the group consisting of a reflex sight, night vision device, video display device, thermal camera, optical sight, and optical magnifier.

18. The method of claim 13, wherein said rotating comprises engaging detents on a rotation joint to releasably retain the optical device at a selected one of the second and third orientations.
